(19) United States
(12) Patent Application Publication
(10) Pub. No.: US 2014/0285373 A1
(43) Pub. Date: Sep. 25, 2014

(54) ON-BOARD RADAR APPARATUS

(71) Applicants: Honda elesys Co., Ltd., Yokohama-shi (JP); National University Corporation Shizuoka University, Shizuoka-ken (JP)

(72) Inventors: Yoshihiko KUWAHARA, Hamamatsu-shi (JP); Hiroyuki KAMO, Yokohama-shi (JP)

(73) Assignees: Honda elesys Co., Ltd., Yokohama-shi (JP); National University Corporation Shizuoka University, Shizuoka-ken (JP)

(21) Appl. No.: 14/218,653

(22) Filed: Mar. 18, 2014

(30) Foreign Application Priority Data
Mar. 19, 2013 (JP) 2013-057071

(51) Int. Cl. G01S 13/04

(52) U.S. Cl. CPC G01S 13/04
USPC 342/27

(57) ABSTRACT

An on-board radar apparatus includes an antenna unit configured by combining one of a lens and a reflector, and a plurality of antenna elements, a transmission and reception unit configured to emit a radio wave using, for at least one of transmission or reception, a partial antenna of a plurality of patterns configured by the antenna elements that are part of the plurality of antenna elements, and to receive a reflection wave obtained by reflection of the radio wave from an object, and a detection unit configured to detect the object based on the reflection wave received by the transmission and reception unit.

### CROSS-REFERENCE TO RELATED APPLICATIONS

This application claims priority on Japanese Patent Application No. 2013-057071 filed Mar. 19, 2013, the contents of which are entirely incorporated herein by reference.

### BACKGROUND OF THE INVENTION

1. Field of the Invention

The present invention relates to an on-board radar apparatus.

2. Description of Related Art

Recently, in order to improve convenience and safety in a vehicle such as an automobile, an on-board radar apparatus is mounted as a detection apparatus. The radar apparatus is divided into a single beam type that performs measurement using a single beam and a multi-beam type that performs measurement using multiple beams. As an on-board radar apparatus of the multi-beam type, a radar apparatus that uses a parabola antenna (for example, see Published Japanese Patent No. 3393204) that includes a primary radiator and a reflector, or a radar apparatus that uses a lens antenna that includes a primary radiator and a lens has been proposed. The lens antenna is configured by a lens that is a main radiator and antenna elements that form an array antenna, for example.

As the lens antenna having a multi-beam function, a technique that provides multiple beams by rotationally symmetrically setting a dielectric constant of the lens (for example, see the Institute of Electronics, Information and Communication Engineers, Antenna engineering handbook, Ohmsha, Ltd., pp. 181, 2008 (Non-Patent Document 1)), a technique that provides multiple beams in an arbitrary direction by optimizing an optical path using a predetermined algorithm (for example, Tomoaki Ide, Yoshihiko Kuwahara, Hiroyuki Kamo, Junji Kanamoto, “DOA Estimation with Super Resolution Capabilities Using a Multi-beam Antenna of the Dielectric lens”, ISAP, FrF4-2, 2011 (Non-Patent Document 2)), or the like has been proposed.

Furthermore, in the multi-beam type radar apparatus using the lens antenna, there is a type in which antenna elements that form an array antenna are mechanically moved around a focal position of the lens, and a type in which plural antenna elements are fixed and a focus of each antenna element is arranged to match a focus of the lens. FIG. 18 is a diagram illustrating an example of a lens antenna 900 based on multiple horn antennas and a lens in the related art. In FIG. 18, a transverse direction of the paper plane is referred to as an x-axis direction, and a longitudinal direction is referred to as a y-axis direction. As shown in FIG. 18, multiple horn antennas 901 are arranged to match a focus of a lens 911. Each horn antenna 901 includes a horn 902. By arranging the lens 911 and the multiple horn antennas 901 in this way, the lens antenna 900 emits five beams 921 (for example, see Non-Patent Document 2). Furthermore, as shown in FIG. 18, each horn antenna 901 is arranged to form a predetermined angle with respect to the y-axis direction.

### SUMMARY OF THE INVENTION

However, in the related art in which the horn antennas are fixedly arranged, the angle of the horn antenna 901 with respect to the y-axis direction becomes larger according to an emission angle as shown in FIG. 18. Thus, there is a problem in that the volume of the lens antenna 900 becomes large. Particularly, as shown in FIG. 18, when the horn antennas 901 are fixedly arranged without movement, the number of the beams 921 is limited by an interval of the horn antennas 901 and the size of each horn antenna 901.

On the other hand, in an arrangement similar to the arrangement in FIG. 18, when the horn antennas 901 are moved to form a multi-beam type lens antenna, it is necessary to provide a position adjustment movable section that moves the horn antenna 901 in the x-axis direction and the y-axis direction while maintaining the distance between a focus 912 of the lens 911 and the horn antenna 901 to a predetermined value, and a rotation adjustment movable section that adjusts the emission angle of the horn antenna 901. Since the position adjustment movable section and the rotation adjustment movable section should have high adjustment accuracy, and thus, the cost of the lens antenna increases. Thus, it is difficult to apply this lens antenna to consumer products. In order to solve these problems, an object of the invention is to provide an on-board radar apparatus capable of detecting the azimuth of a detection object with high accuracy without increasing the size and cost of the radar apparatus.

(1) In order to achieve the above object, an on-board radar apparatus according to an aspect of the invention includes: an antenna unit configured by combining one of a lens and a reflector, and a plurality of antenna elements; a transmission and reception unit configured to emit a radio wave using, for at least one of transmission or reception, a partial antenna of a plurality of patterns configured by the antenna elements that are part of the plurality of antenna elements, and to receive a reflection wave obtained by reflection of the radio wave from an object; and a detection unit configured to detect the object based on the reflection wave received by the transmission and reception unit.

(2) In the on-board radar apparatus according to an aspect of the invention, a combination of the antenna elements that form the partial antenna may be selected according to a characteristic of one of the lens and the reflector.

(3) The on-board radar apparatus according to an aspect of the invention may further include a phase control unit configured to control a phase of a signal based on a radio wave received by the antenna elements that form the partial antenna, based on at least one of the number of the antenna elements that form the partial antenna, an interval of the antenna elements, a value indicating directionality of the antenna elements and an aperture surface of an array antenna configured by the plurality of antenna elements.

(4) The on-board radar apparatus according to an aspect of the invention may further include an amplitude control unit configured to control an amplitude of a signal based on a radio wave received by the antenna elements that form the partial antenna, based on at least one of the number of the antenna elements that form the partial antenna, an interval of the antenna elements, a value indicating directionality of the antenna elements and an aperture surface of an array antenna configured by the plurality of antenna elements.

(5) The on-board radar apparatus according to an aspect of the invention may further include both of the phase control unit and the amplitude control unit.

(6) In the on-board radar apparatus according to an aspect of the invention, the plurality of antenna elements may be arranged in a straight line.

(7) In the on-board radar apparatus according to an aspect of the invention, at least one of the number of the antenna elements that form the partial antenna, the interval of the antenna elements, the value indicating the directionality of the antenna elements and the aperture surface of the array antenna configured by the plurality of antenna elements may be selected according to a characteristic of one of the lens and the reflector.

(8) Furthermore, the on-board radar apparatus according to an aspect of the invention may further include the phase control unit and the amplitude control unit, and the phase control unit may adjust the phase of the signal received by the antenna elements that form the partial antenna so that a side lobe point of an antenna pattern of a first antenna element that is one of the plurality of antenna elements included in the partial antenna and a null point of a second antenna element that is included in the partial antenna and is one of the plurality of antenna elements except the first antenna element overlap each other, and the amplitude control unit may adjust the amplitude of the signal received by the antenna elements that form the partial antenna so that the side lobe point of the antenna pattern of the first antenna element and the null point of the second antenna element overlap each other.

According to the on-board radar apparatus of the various aspects of the invention, it is possible to detect the azimuth of a detection object with high accuracy without increasing the size and cost of the radar apparatus.

### BRIEF DESCRIPTION OF THE DRAWINGS

FIG. 1 is a diagram schematically illustrating a configuration of a radar apparatus according to a first embodiment.

FIG. 2 is a block diagram illustrating a configuration of a transmission and reception control device according to the first embodiment.

FIG. 3 is a diagram illustrating information stored in a storage unit according to the first embodiment.

FIG. 4 is a diagram illustrating a control timing in a phase control unit and an amplitude control unit according to the first embodiment.

FIG. 5 is a diagram illustrating adjustment of a phase weight and an excitation weight according to the first embodiment.

FIG. 6 is a diagram illustrating diffraction and scattering in a lens end part.

FIG. 7 is a diagram illustrating the relationship between a side lobe and a spillover.

FIG. 8 is a diagram illustrating a cross point in a multi-beam antenna.

FIG. 9 is a diagram illustrating an example of a beam pattern in adjustment of a phase weight of an antenna according to the first embodiment.

FIG. 10 is a diagram schematically illustrating a configuration of a radar apparatus based on a transmission reflector according to the first embodiment.

FIG. 11 is a diagram illustrating an example of a bifocal lens according to a second embodiment.

FIG. 12 is a diagram schematically illustrating a configuration of a radar apparatus that uses the bifocal lens according to the second embodiment.

FIG. 13 is a diagram illustrating another combination of an array antenna according to the second embodiment.

FIG. 14 is a diagram illustrating an example of a beam pattern when the bifocal lens according to the second embodiment is used.

FIG. 15 is a block diagram illustrating a configuration of a transmission and reception control device according to a third embodiment.

FIG. 16 is a diagram illustrating an antenna pattern based on a reception antenna element according to the third embodiment.

FIG. 17 is a block diagram illustrating a transmission and reception control device according to a fourth embodiment.

FIG. 18 is a diagram illustrating an example of multiple horn antennas and a lens antenna using a lens in the related art.

### DETAILED DESCRIPTION OF THE INVENTION

### First Embodiment

Hereinafter, embodiments of the invention will be described with reference to the accompanying drawings.

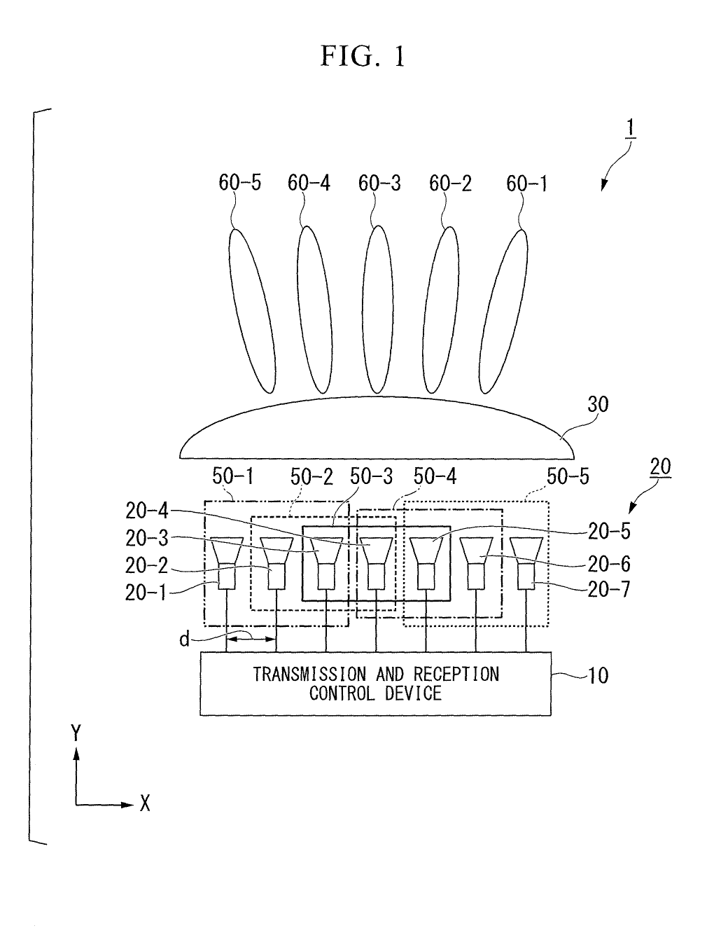

FIG. 1 is a diagram schematically illustrating a configuration of a radar apparatus 1 according to a first embodiment. As shown in FIG. 1, the radar apparatus 1 includes a transmission and reception control device 10, an antenna unit 20, and a lens 30. In FIG. 1, a transverse direction on the paper plane is referred to as an x-axis direction, and a longitudinal direction on the paper plane is referred to as a y-axis direction.

The transmission and reception control device 10 distributes a transmission signal that is generated inside, and controls the phase and amplitude of the distributed transmission signal to supply the result to each of antenna elements 20-1 to 20-7. Furthermore, the transmission and reception control device 10 performs detection of an object based on a reception signal received by each of the antenna elements 20-1 to 20-7.

The antenna unit 20 includes seven antenna elements 20-1 to 20-7. Furthermore, as shown in FIG. 1, the antenna unit 20 has an array-of-array configuration in which three antenna elements are selected from seven array antennas. Each antenna element 20-n (where n is an integer of 1 to 7) includes a primary radiator (horn) having the same characteristic. The horn included in each antenna element 20-n is a fan type horn, a cone type horn or a pyramid type horn, for example. Furthermore, each antenna element 20-n is arranged so that an emission (antenna aperture) direction of each antenna element 20-n is perpendicular to the x-axis direction. An interval between the antenna elements 20-n is equal in the x-axis direction, which is referred to as an interval “d”.

The lens 30 is a lens for transmission and reception. A specific dielectric constant of the lens 30 is 1 or greater.

An array antenna (may be referred to as a partial antenna) 50-1 includes three antenna elements 20-1, 20-2 and 20-3. An array antenna 50-2 includes three antenna elements 20-2, 20-3 and 20-4. An array antenna 50-3 includes three antenna elements 20-3, 20-4 and 20-5. An array antenna 50-4 includes three antenna elements 20-4, 20-5 and 20-6. An array antenna 50-5 includes three antenna elements 20-5, 20-6 and 20-7.

A beam 60-1 represents a directionality of a beam received by the array antenna 50-1 through the lens 30. A beam 60-2 represents a directionality of a beam received by the array antenna 50-2 through the lens 30. A beam 60-3 represents a directionality of a beam received by the array antenna 50-3 through the lens 30. A beam 60-4 represents a directionality of a beam received by the array antenna 50-4 through the lens 30. A beam 60-5 represents a directionality of a beam received by the array antenna 50-5 through the lens 30. That is, the radar apparatus 1 shown in FIG. 1 forms five sets of array antennas by the seven antenna elements 20-n and the lens 30 to provide five beams.

In the following description, an example in which at least one antenna element among the antenna elements 20-1 to 20-7 performs transmission and the array antennas 50-1 to 50-5 perform reception will be described.

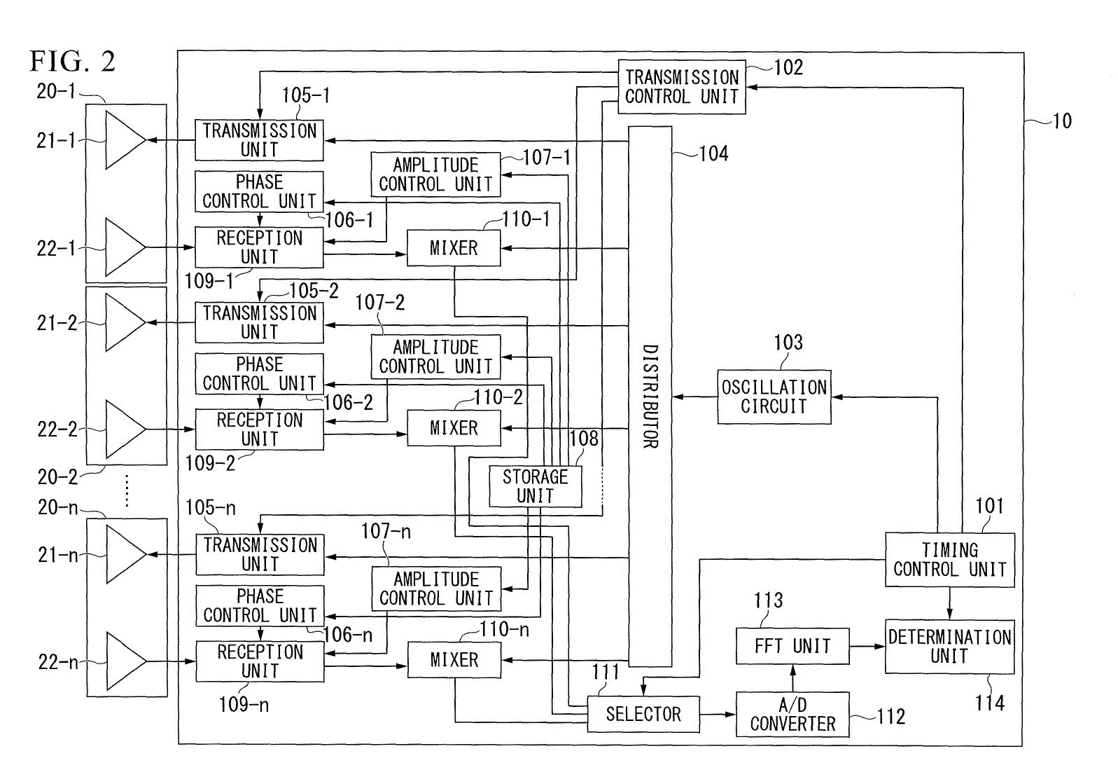

FIG. 2 is a block diagram illustrating a configuration of the transmission and reception control device 10 according to the first embodiment. The transmission and reception control device 10 shown in FIG. 2 includes a timing control unit 101, a transmission control unit 102, an oscillation circuit 103, a distributor 104, a transmission unit (transmission and reception unit) 105-n (n is an integer of 1 to 7), a phase control unit 106-n, an amplitude control unit 107-n, a storage unit 108, a reception unit (transmission and reception unit) 109-n, a mixer 110-n, a selector 111, an A/D (analogue-digital signal) converter 112, a fast Fourier transform (FFT) unit 113, and a determination unit 114.

The antenna element 20-n (n is an integer of 1 to 7) includes a transmission antenna element 21-n and a reception antenna element 22-n. The transmission antenna element 21-n and the reception antenna element 22-n share one antenna element. Furthermore, in the transmission and reception control device 10 according to the first embodiment, at least one transmission antenna element 21-n may be provided.

The transmission antenna element 21-n emits a radio wave supplied from the transmission unit 105-n.

The reception antenna element 22-n receives a reflection wave obtained by reflection of a beam emitted from the transmission antenna element 21-n from an object, and converts the received reflection wave into a reception signal. The reception antenna element 22-n outputs the reception signal to the reception unit 109-n.

The timing control unit 101 outputs an oscillation control signal synchronized with a synchronization signal to the oscillation circuit 103, outputs a transmission selection signal to the transmission control unit 102, outputs a reception selection signal to the selector 111, and outputs the synchronization signal to the determination unit 114.

The transmission control unit 102 outputs a transmission control signal to the transmission unit 105-n according to the transmission selection signal input from the timing control unit 101.

The oscillation circuit 103 generates, when a frequency-modulated conductive-wave (FMCW) method is used, for example, a signal of a frequency that is proportional to a voltage level of the oscillation control signal input from the timing control unit 101. The oscillation circuit 103 performs amplification of the level while multiplying the generated signal by a predetermined frequency, and outputs the amplified signal to the distributor 104 as a transmission signal.

The distributor 104 distributes the transmission signal input from the oscillation circuit 103, and outputs the distributed transmission signal to the transmission unit 105-n and the reception unit 109-n.

The transmission unit 105-n supplies a transmission signal obtained by multiplying the transmission signal input from the distributor 104 by an n-fold frequency to one transmission antenna element 21-n selected according to the transmission control signal input from the transmission control unit 102. The number of the transmission antenna elements 21-n used for transmission may be fixed to one. Furthermore, when the number of the transmission antenna elements 21-n is two, the transmission unit 105-n may select one transmission antenna element 21-n according to the transmission control signal input from the transmission control unit 102.

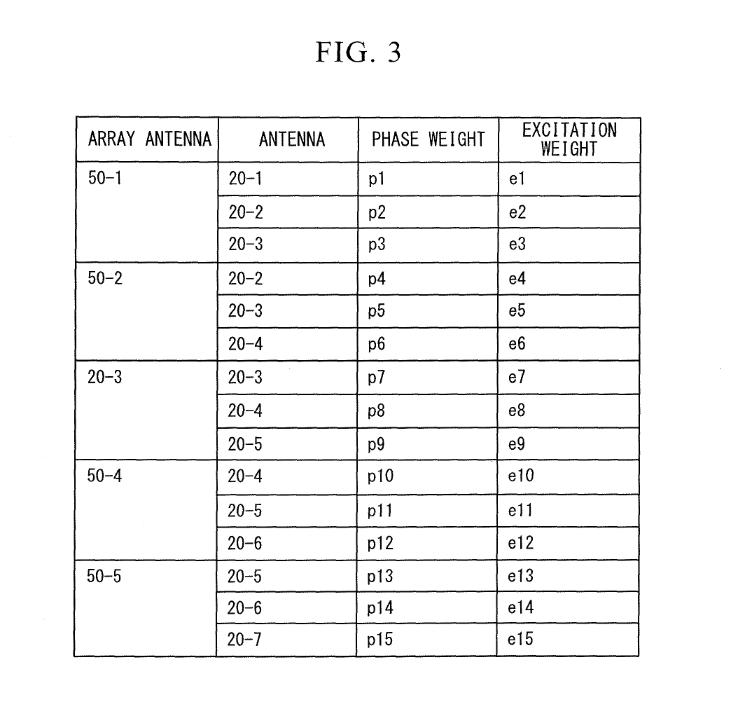

As shown in FIG. 3, antenna identification information, a phase weight and an excitation weight are stored in association in the storage unit 108 for each array antenna 50-n. FIG. 3 is a diagram illustrating the information stored in the storage unit 108 according to the first embodiment. The phase weight and the excitation weight will be described later.

For example, antenna identification information 20-1 to 20-3 is stored in association in the array antenna 50-1. Furthermore, a phase weight p1 and an excitation weight e1 are stored in association in the antenna identification information 20-1. Here, the antenna identification information refers to identification information for identifying each antenna element 20-n.

The reception unit 109-n outputs the reception signal input from the reception antenna element 22-n to the mixer 110-n.

The phase control unit 106-n reads the phase weight stored in the storage unit 108 and controls the phase of the reception signal received by the reception unit 109-n according to the read phase weight.

The amplitude control unit 107-n reads the excitation weight stored in the storage unit 108 and controls the amplitude of the reception signal received by the reception unit 109-n according to the read excitation weight.

The mixer 110-n mixes the reception signal input from the reception unit 109-n with a signal of a frequency that is twice the frequency of the transmission signal input from the distributor 104 to generate a beat signal. The mixer 110-n outputs the generated beat signal to the selector 111.

The selector 111 selects the array antenna 50-n stored in the storage unit 108 by the reception selection signal from the timing control unit 101. The selector 111 selects three elements from among the seven reception antenna elements 22-n based on the antenna identification information stored in the storage unit 108 in association with the selected array antenna 50-n. The selector 111 synthesizes the reception signals after phase control and amplitude control, received through the selected three reception antenna elements 22-n, and outputs the synthesized reception signal in the array antenna 50-n to the A/D converter 112.

The A/D converter 112 converts the reception signal input from the selector 111 into a digital signal, and outputs the result to the FFT unit 113 as a digital reception signal that is the converted digital signal.

The FFT unit 113 performs Fourier transform for the digital reception signal input from the A/D converter 112, and outputs the Fourier transformed signal to the determination unit 114 as a frequency spectrum signal.

The determination unit 114 detects a distance and an azimuth from the frequency spectrum signal input from the FFT unit 113 to a reflective object.

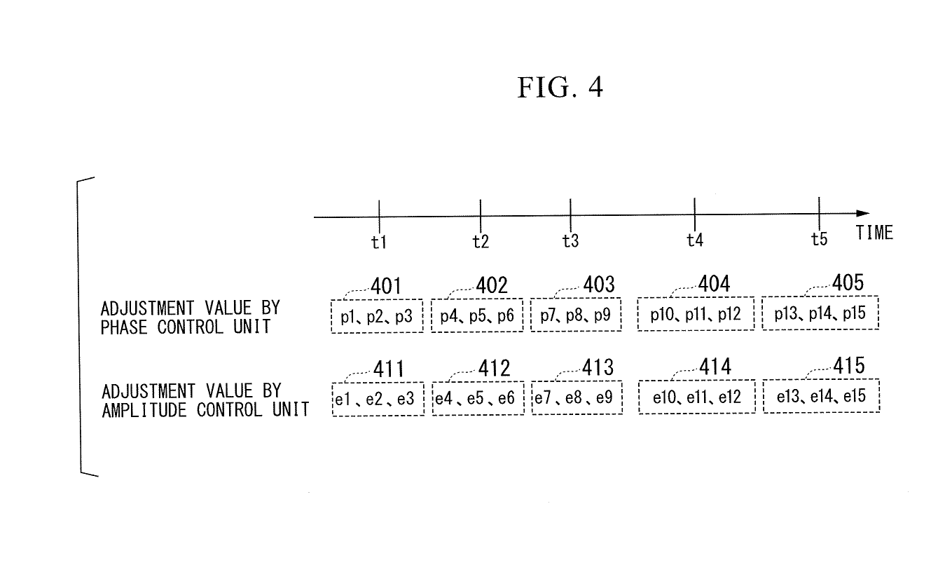

FIG. 4 is a diagram illustrating a control timing in the phase control unit 106-n and the amplitude control unit 107-n according to the first embodiment. In FIG. 4, the transverse axis represents time. Reference numerals 401 to 405 represent combinations of the phase weights of three antenna elements, and reference numerals 411 to 415 represent combinations of the excitation weights of three antenna elements.

At time t1, as shown in the combination 401, the phase control unit 106-1 controls the phase weight of the antenna element 20-1 to p1, the phase control unit 106-2 controls the phase weight of the antenna element 20-2 to p2, and the phase control unit 106-3 controls the phase weight of the antenna element 20-3 to p3. Furthermore, at time 1, as shown in the combination 411, the amplitude control unit 107-1 controls the excitation weight of the antenna element 20-1 to e1, the amplitude control unit 107-2 controls the excitation weight of the antenna element 20-2 to e2, and the amplitude control unit 107-3 controls the excitation weight of the antenna element 20-3 to e3.

At time t2, as shown in the combination 402, the phase control unit 106-2 controls the phase weight of the antenna element 20-2 to p4, the phase control unit 106-3 controls the phase weight of the antenna element 20-3 to p5, and the phase control unit 106-4 controls the phase weight of the antenna element 20-4 to p6. Furthermore, at time 2, as shown in the combination 412, the amplitude control unit 107-2 controls the excitation weight of the antenna element 20-2 to e4, the amplitude control unit 107-3 controls the excitation weight of the antenna element 20-3 to e5, and the amplitude control unit 107-4 controls the excitation weight of the antenna element 20-4 to e6.

Subsequently, similarly, at time t3, the phase control units 106-3 to 106-5 control the phases of the corresponding antenna elements 20-3 to 20-5 as shown in the combination 403, and the amplitude control units 107-3 to 107-5 control the amplitudes of the corresponding antenna elements 20-3 to 20-5 as shown in the combination 413. At time t4, the phase control units 106-4 to 106-6 control the phases of the corresponding antenna elements 20-4 to 20-6 as shown in the combination 404, and the amplitude control units 107-4 to 107-6 control the amplitudes of the corresponding antenna elements 20-4 to 20-6 as shown in the combination 414. At time t5, the phase control units 106-5 to 106-7 control the phases of the corresponding antenna elements 20-5 to 20-7 as shown in the combination 405, and the amplitude control units 107-5 to 107-7 control the amplitudes of the corresponding antenna elements 20-5 to 20-7 as shown in the combination 415. After the process at time t5, the control is repeated in the order of the processes at time t1 to t5. Alternatively, after the process at time t5, the process at time t4, the process at time t3, . . . , and the process at time t1 may be repeatedly performed.

In this way, by adjusting the phase weight of each antenna element 20-n, in the radar apparatus 1 according to the first embodiment, it is possible to arrange a wave surface in a desired direction. Furthermore, since the radar apparatus 1 according to the first embodiment shares the antenna element 20-n, an aperture becomes substantially large, and thus, it is possible to obtain an effect of narrowing the beam.

In FIG. 2, an example in which the phase control unit 106-n and the amplitude control unit 107-n are provided for each antenna element 20-n is shown, but in this case, one phase control unit 106-n and one amplitude control unit 107-n may be respectively provided. When only one phase control unit 106-n is provided, the phase of each antenna element 20-n may be controlled in a time divisional manner at times t1, t2, . . . , t5 to control. Only one phase control unit 106-n and one amplitude control unit 107-n may be provided. When only one amplitude control unit 107-n is provided, the amplitude of each antenna element 20-n may be controlled in a time divisional manner at times t1, t2, . . . , t5.

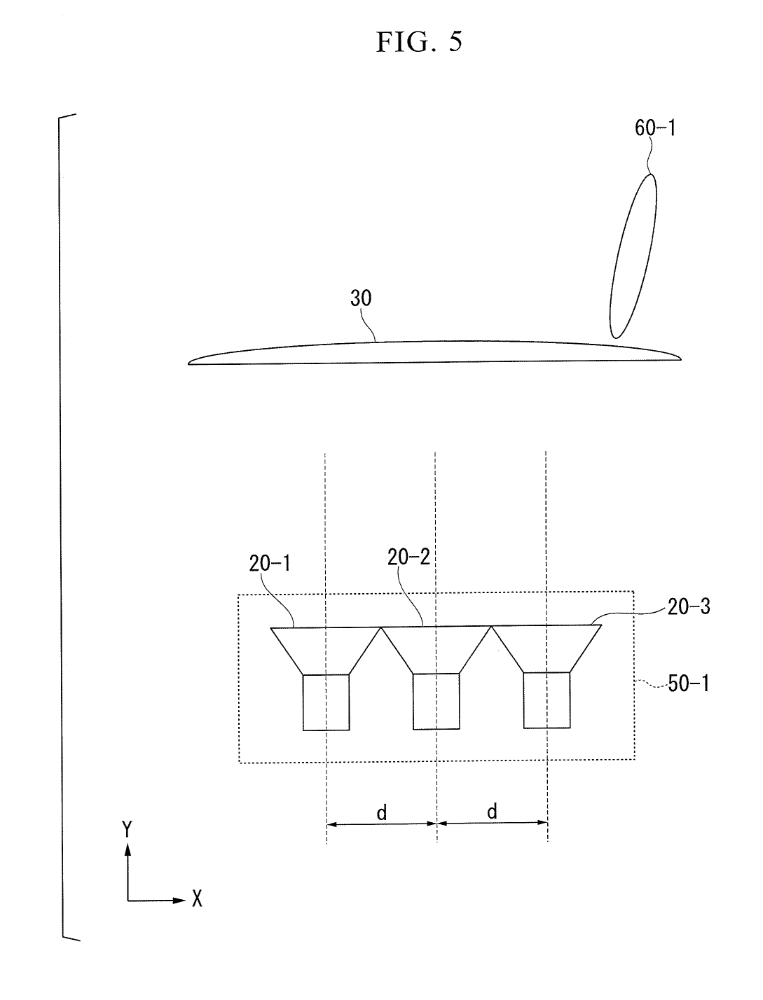

FIG. 5 is a diagram illustrating the adjustment of the phase weight and the excitation weight according to the first embodiment. In FIG. 5, a transverse direction is referred to as an x-axis direction, and a longitudinal direction is referred to as a y-axis direction. In the example shown in FIG. 5, only the array antenna 50-1 among the array antennas 50-n is extracted for description.

Here, the following Expression (1) represents an array factor (array coefficient) f(θ). The array factor f(θ) is a factor determined by the interval d of the antenna elements and current fed to the antenna elements, which represents the directionality of the array antenna 50-1, that is, the beam width of the array antenna 50-1.

f(θ)=D(θ)×w(1+e^{jφ}+e−^{jφ}+e^{j2φ}+e^{-j2φ}+ . . . +e^{-j(N-1)φ}+e^{-j(N-1)φ}) (1)

In Expression (1), D(θ) represents a value indicating the directionality of one of the antenna elements 20-1 to 20-3, N represents the number (=3) of the antenna elements 20-1 to 20-3, and w represents the excitation weight. In Expression (1), f(θ), D(θ) and N are known values. Furthermore, in Expression (1), ψ is represented as follows.

ψ=kd×cos θ+δ (2)

In Expression (2), k represents a propagation constant, and δ represents a current phase difference of transmission signals supplied to the antenna elements 20-1 to 20-3. If the maximum emission direction is θ=θ₀ and the current phase difference 8 between the antenna elements 20-1 to 20-3 is selected as −kd×cos θ so that the radio waves emitted from the antenna elements 20-1 to 20-3 have the same phase in the θ₀ direction, ψ is as follows.

ψ=kd(cos θ−cos θ₀) (3)

In Expression (3), θ₀ represents the phase weight.

A designer of the radar apparatus 1 calculates the interval d of the antenna elements that satisfy the Expression (1).

Since the beam width is determined by the length of aperture of the antenna elements 20-1 to 20-n, the designer of the radar apparatus 1 determines the entire length of the array arrangement. Thus, as the designer determines the number of antenna elements capable of being set, the interval d of the antenna elements is physically determined. Here, since the emission direction of each of the antenna elements 20-1 to 20-n is set for a focus of each lens, the designer adjusts the phase of each of the antenna elements 20-1 to 20-n so that equiphase surfaces are aligned in the emission direction. Then, in order to appropriately perform the feeding to the lens 30, the designer adjusts amplitude distributions of the antenna elements 20-1 to 20-n to determine a side lobe ratio.

In order to obtain a desired antenna directionality in transmission, the designer of the radar apparatus 1 adjusts the phases and amplitudes of the transmission signals supplied to the antenna elements 20-1, 20-2 and 20-3. Furthermore, in order to obtain a desired antenna directionality in reception, the designer of the radar apparatus 1 adjusts the phases and amplitudes of the reception signals received by the antenna elements 20-1, 20-2 and 20-3.

For example, the phases of the reception signals input through the antenna elements 20-1, 20-2 and 20-3 are respectively adjusted by the phase control units 106-1 to 106-3, and thus, the phase weight in Expression (3) is adjusted. Furthermore, the amplitudes of the reception signals input through the antenna elements 20-1, 20-2 and 20-3 are respectively adjusted by the amplitude control units 107-1 to 107-3, the excitation weight in Expression (1) is adjusted. By adjusting the phase weight in the array antenna 50-1, it is possible to adjust scanning of the beam. Furthermore, by adjusting the excitation weight in the array antenna 50-1, it is possible to adjust a side lobe of the beam. The phase weight and the excitation weight are determined for each of the antenna elements 20-1, 20-2 and 20-3. The designer of the radar apparatus 1 stores the adjusted values obtained in this way in the storage unit 108.

The designer of the radar apparatus 1 similarly calculates the phase weight and the excitation weight for each antenna element 20-n with respect to the array antennas 50-2 to 50-5, and stores the calculated phase weight and excitation weight in the storage unit 108.

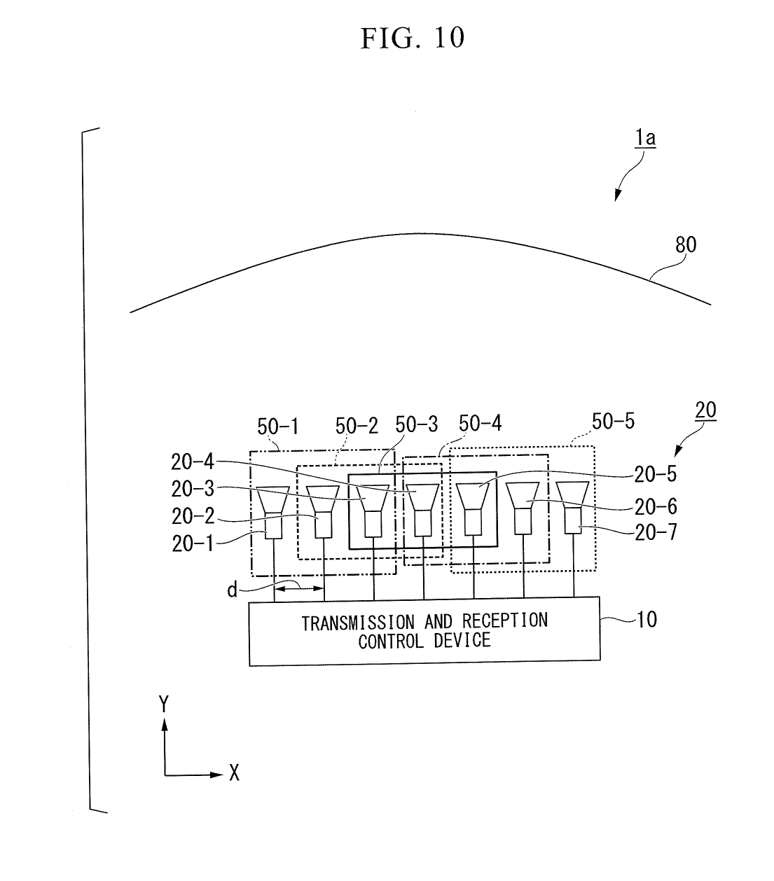

As described above, the radar apparatus 1 according to the first embodiment includes the antenna unit 20 configured by the combination of one of the lens 30 and the reflector 80 (see FIG. 10), and the plural antenna elements 20-n; the transmission and reception unit (transmission unit 105-n and reception unit 109-n) that emits a radio wave using at least one of transmission and reception of the partial antenna (array antenna 50-n) of plural patterns configured by the antenna elements 20-n that are a part of the plural antenna elements 20-n, and receives a reflection wave obtained by reflection of the radio wave from an object; and the detection unit (determination unit 114) that performs detection of the object based on the reflection wave received by the transmission and reception unit (transmission unit 105-n and the reception unit 109-n).

With such a configuration, the radar apparatus 1 according to the first embodiment can detect the azimuth of the detected object with high accuracy by the combination of the array-of-array antenna (partial antenna) and the lens 30 (or the reflector (to be described later with reference to FIG. 10)) without increasing the size and cost of the radar apparatus.

Furthermore, the radar apparatus 1 according to the first embodiment includes the phase control unit 106-n that controls the phase of a signal based on the radio wave received by the antenna element 20-n that forms the partial antenna, based on at least one of the number of the antenna elements 20-n that form the partial antenna (array antenna 50-n), the interval of the antenna elements 20-n, the value indicating the directionality of the antenna element 20-n and the aperture of the array antenna. Furthermore, the radar apparatus 1 according to the first embodiment includes the amplitude control unit 107-n that controls the amplitude of the signal based on the radio wave received by the antenna element 20-n that forms the partial antenna, based on at least one of the number of the antenna elements 20-n that form the partial antenna (array antenna 50-n), the interval of the antenna elements 20-n, the value indicating the directionality of the antenna elements 20-n and the aperture surface of the array antenna.

With such a configuration, in the radar apparatus 1 according to the first embodiment, it is possible to change the beam direction by adjusting the phase, and it is thus possible to electrically adjust the emission direction without physically moving the emission direction of the antenna element. Furthermore, in the radar apparatus 1 according to the first embodiment, it is possible to change the side lobe by adjusting the amplitude.

In the first embodiment, an example in which the adjustment (synthesis of directivities) of the side lobe is performed by the adjacent reception antenna elements 22-n is described, but the invention is not limited to this embodiment. The adjustment of the side lobe (synthesis of directivities) may be performed by the adjacent transmission antenna elements 21-n. Furthermore, when the directivities of the transmission antenna element 21-n and the reception antenna element 22-n are different from each other, the adjustment of the side lobe (synthesis of directivities) may be performed by a combination of the transmission antenna element 21-n and the reception antenna element 22-n.

(Description about Effects Relating to Volume of Primary Radiator)

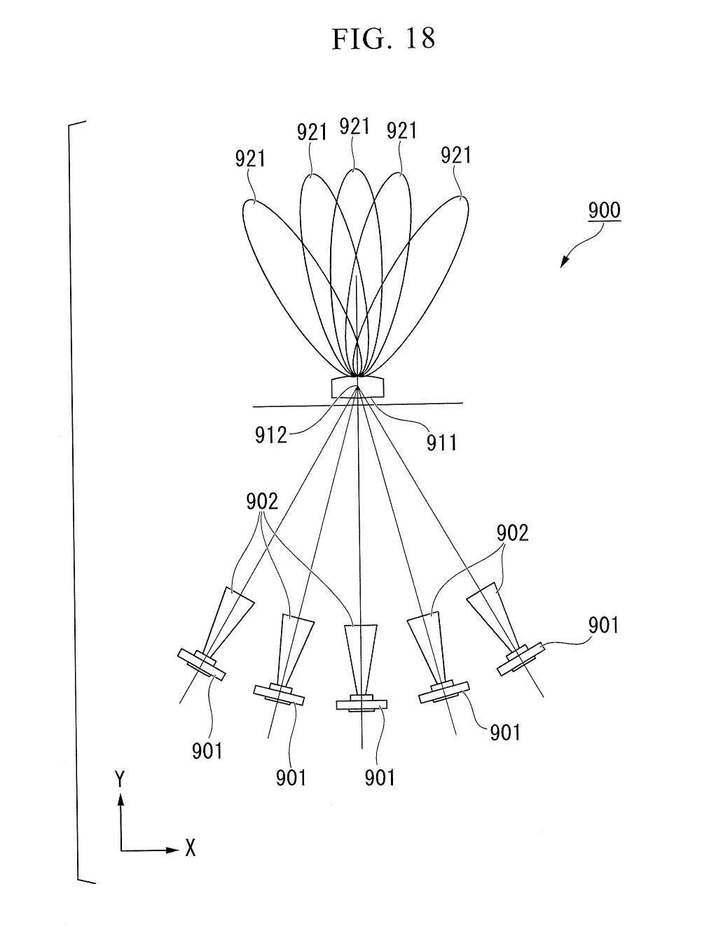

In the related art, in an arrangement similar to an arrangement shown in FIG. 18, when horn antennas 901 are moved to form a multi-beam radar apparatus, it is necessary to provide a position adjusting movable section that adjusts a distance between a focus 912 of a lens 911 and the horn antenna 901 in an x-axis direction and a y-axis direction so that the distance becomes a predetermined interval, and a rotation adjusting movable section that adjusts an emission angle of the horn antenna 901. In the position adjusting movable section and the rotation adjusting movable section, high adjustment accuracy is required, and thus, the cost of the radar apparatus increases. Thus, it is difficult to apply the radar apparatus to consumer products.

In the radar apparatus 1 according to the first embodiment, since it is possible to change the beam direction by adjusting the phase weight as described in Expression (1), it is possible to electrically adjust the emission direction without physically moving the emission direction of the antenna element 20-n. For example, as shown in FIG. 1, since the antenna elements 20-n are linearly arranged in the x-axis direction, compared with the related art described with reference to FIG. 18, it is possible to efficiently arrange the antenna elements 20-n with a small volume.

Furthermore, in the array antenna in the related art, if an emission range to be adjusted is large, the antenna directionality deteriorates, whereas in the radar apparatus 1 according to the first embodiment, by forming an appropriate combination of the array antenna 50-n for each angle range, it is possible to provide relatively stable feeding. Furthermore, in the radar apparatus 1 according to the first embodiment, by adjusting the amplitude weight to control the side lobe level, it is possible to handle deterioration of the directionality due to the angle change.

Focus adjustment in the longitudinal direction depends on a setting condition of the emission angle range, but when the focuses are within a design allowable range or can be handled by lens design, it is possible to array the focuses using a predetermined algorithm without adjustment in the longitudinal direction (linear array). If this condition is satisfied, by combining patch antennas, slit antennas or the like, it is possible to provide the primary radiator unit that is the antenna unit 20 as a general plane printed circuit board.

(Description about Effects Relating to Influence of Spillover)

In an open type antenna method that optically converts an electromagnetic wave emitted from a wave source such as a radar apparatus or a parabola antenna into a plane wave, a radio wave (spillover) that is directly emitted from a lens or a reflecting mirror without passage may cause a problem.

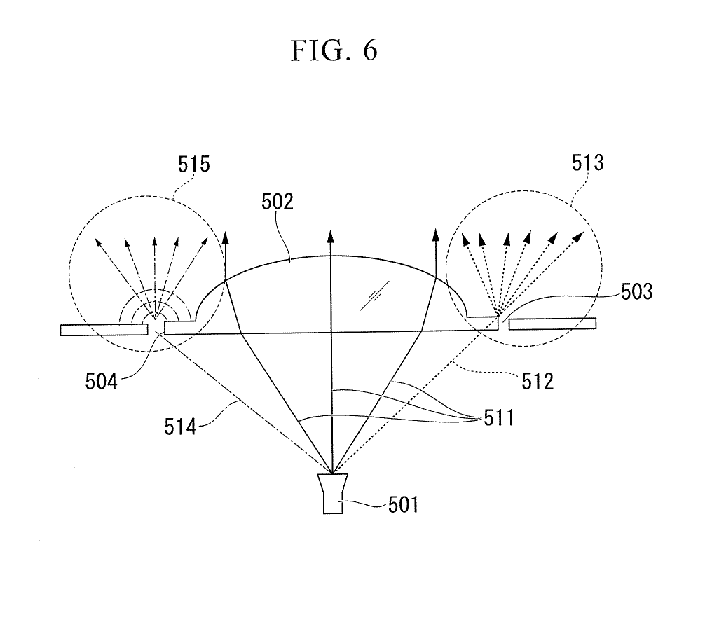

FIG. 6 is a diagram illustrating diffraction and scattering in a lens end part. In FIG. 6, a reference numeral 501 represents a horn antenna (primary feed horn), and a reference numeral 502 represents a lens. A reference numeral 511 represents a direct passage light that directly passes through the lens 502 among the radio wave emitted from the primary feed horn. A reference numeral 503 represents a gap between the lens 502 and a mounting section. A reference numeral 504 represents an end part of the lens 502.

A radio wave 512 that reaches the end part of the lens 502 is scattered by the end part of the lens 502 to generate a radio wave 513. Furthermore, a radio wave 514 that reaches the gap between the lens 502 and the mounting section by the gap is diffracted by the gap to generate a radio wave 515. The scattered radio wave 513 and the diffracted radio wave 515 are directly emitted without being converted into a plane wave, and thus, all of the scattered radio wave 513 and the diffracted radio wave 515 do not contribute to a desired emission, which causes a loss.

Furthermore, at the end part of the lens 502, the electromagnetic wave due to the spillover reaches a lens opening part by diffraction and scattering, so that the amplitude and phase distribution at the opening part are disturbed. The diffraction and scattering also occur at an end part of the reflecting mirror. Thus, the antenna directionality is disturbed.

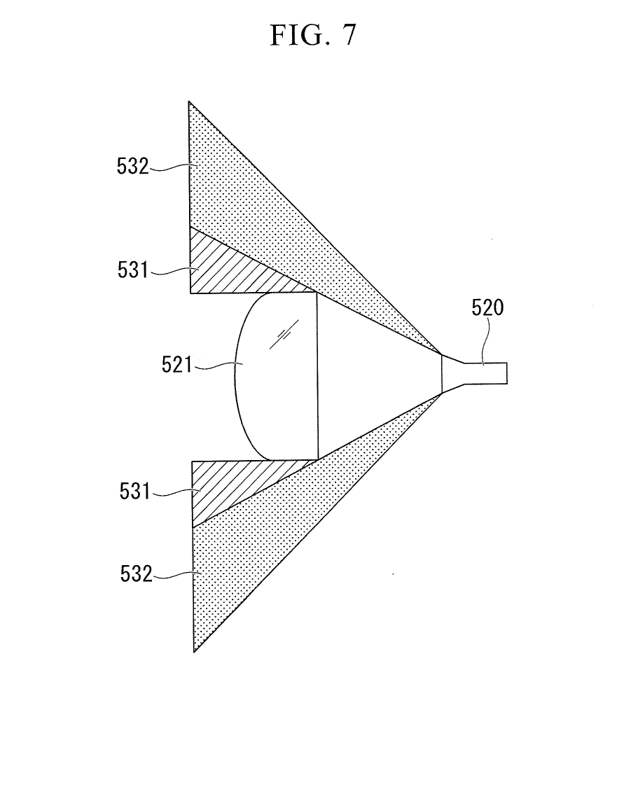

Furthermore, as shown in FIG. 7, when an electromagnetic wave that is directly emitted from the edge of a lens 521 is strong, a side lobe level due to the strong electromagnetic wave is too large to be ignored. FIG. 7 is a diagram illustrating the relationship between the side lobe and the spillover. In FIG. 7, a reference numeral 520 represents a horn antenna, and a reference numeral 521 represents a lens. Furthermore, a region indicated by a reference numeral 531 corresponds to a region where the radio wave is generated due to the diffraction and scattering at the above-described lens end part. A region indicated by a reference numeral 532 corresponds to a region that the electromagnetic wave (spillover wave) that is directly emitted from the edge of the lens reaches.

As shown in FIG. 7, in a lens that particularly forms a wide angle beam, since the length of the lens aperture is short, the region 532 becomes large, and the influence of the side lobe level is remarkably exhibited. As described above, the spillover becomes a cause that significantly degrades the antenna performance.

In order to suppress the spillover, the following techniques (I) and (II) are proposed.

(I) By installing a wave absorber or a metal wall in the vicinity of a lens or a reflecting mirror, the spillover is electrically shielded (the Institute of Electronics, Information and Communication Engineers (EIC), “antenna engineering handbook”, Ohmsha, Ltd., pp. 301).

(II) By narrowing an antenna beam by a primary radiator, the antenna beam is sprayed to the lens or reflecting mirror with high efficiency.

In the shielding technique (I), since a shielding region capable of reducing the influence due to the spillover should be provided in the vicinity of the lens, the cross section of the entire antenna becomes large. In processing of the shielding region, a material capable of reflecting or attenuating an electromagnetic wave is provided. For example, in the technique (I), adhesion of a metal film or a conductor plating painting is performed for reflection. In the technique (I), foamed resin containing carbon powder is attached to the surface for attenuation. In the technique (I), any technique for reflection or attenuation results in high cost processing. Furthermore, from the viewpoint of performance, in the technique (I), when the reflecting material is used, since a reflection wave is scattered inside an antenna module, there is a concern that a noise level increases. Furthermore, in the attenuating material of the technique (I), since an attenuation characteristic is changed by an incident angle of an electromagnetic wave, it is difficult to obtain a stable suppression effect.

Next, in the technique (II) that narrows the antenna beam, for example, assuming that the horn antenna type is employed, for example, the beam is narrowed by lengthening the depth to enlarge the antenna aperture, but in this case, the antenna is excessively increased in size (the Institute of Electronics, Information and Communication Engineers (EIC), “antenna engineering handbook”, Ohmsha, Ltd., p. 393, 2008). Furthermore, a technique that narrows an antenna beam by addition of a three-dimensional wave guide such as a dielectric rod antenna (the Institute of Electronics, Information and Communication Engineers (EIC), “antenna engineering handbook”, Ohmsha, Ltd., pp. 94-95, 2008) or a parasitic metal element has been proposed, but the number of components is large, and the structure is complicated.

Furthermore, when a plane shape is preferentially considered by a substrate mounted patch antenna, a technique that narrows a beam by addition of a plane antenna or an array component provided with a parasitic element has been proposed. However, it is very difficult to provide an electric design on a flexible board, and it is necessary to provide an aperture area that is equal to or larger than that of a three-dimensional antenna, and thus, it is difficult to secure an array space.

On the other hand, the radar apparatus 1 according to the first embodiment forms the array antennas 50-n while sharing the adjacent antenna element 20-n, as shown in FIG. 1. Thus, in the radar apparatus 1 according to the first embodiment, an effective aperture area of the antenna is increased, it is possible to narrow the beam with the same area compared with the antenna type in the related art. Consequently, in the radar apparatus 1 according to the first embodiment, it is possible to improve the suppression effect of the spillover.

(Description about Effects Relating to Influence of the Number of Beams)

In a consumer radar apparatus in view of cost, in many cases, a fixed primary radiator is selected. A condition that determines the number of multi-beams will be described.

(III) Basically, the number of mounted transmitters or receivers becomes the number of multi-beams, but a transmission and reception device of a microwave or millimeter wave band where the radar apparatus is mainly and positively used is expensive. Thus, in the consumer radar apparatus, the number of mounted antenna elements is normally set to as small as possible.

(IV) Since the distance between focuses of beams is extremely narrow in design of a high gain lens, it is difficult to array many elements.

(V) In design of a wide angle antenna, it is difficult to arrange many focuses in order to compatibly satisfy “the condition that primary radiators are arranged to have a predetermined angle with respect to the y-axis direction (see FIG. 18)” and “the condition that since the lens width is narrow, a countermeasure to the spillover (narrowing of the beam) is necessary”.

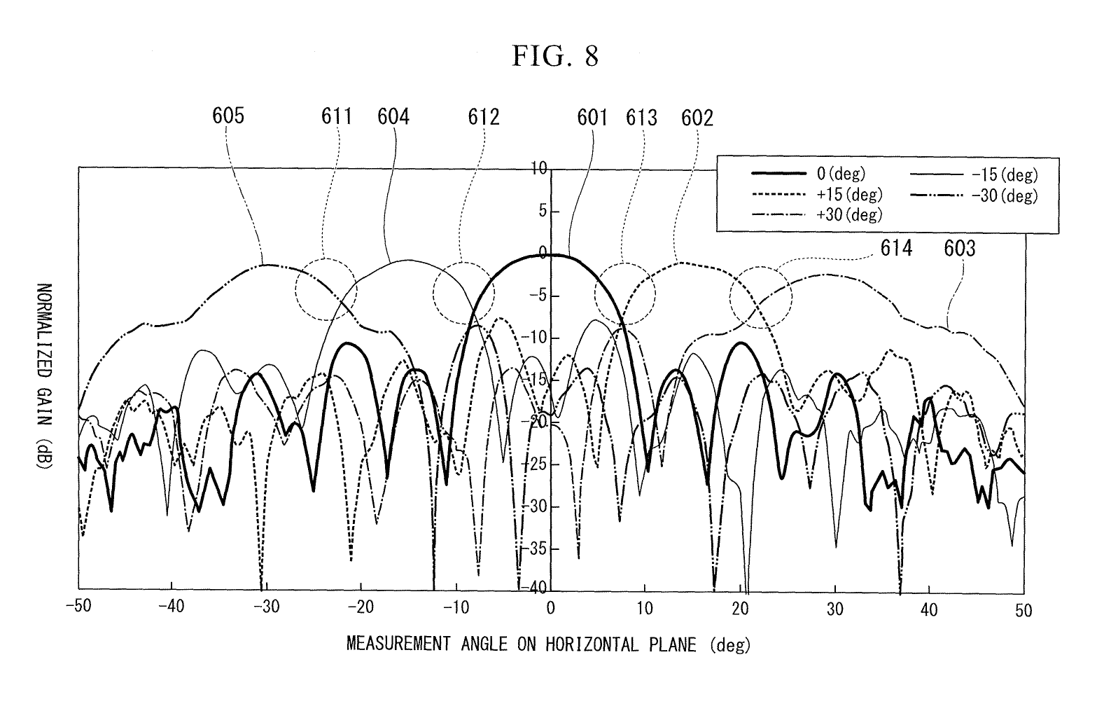

As shown in (III) to (V), it is preferable that the number of beams is large, but in view of the cost condition or the design restriction of the primary radiators, it is difficult to arrange many antenna elements. Here, as shown in FIG. 8, in the radar apparatus in the related art, in many cases, since the drop of a gain of a cross point between beams directly leads to deterioration of performance, it is necessary to increase the number of beams as much as possible. FIG. 8 is a diagram illustrating cross points in the multi-beam antenna. In FIG. 8, the transverse axis represents an observation angle, and the longitudinal axis represents a normarized gain.

In FIG. 8, a curve 601 represents a characteristic of a beam of which the gain becomes the maximum at an observation angle of 0 degrees, a curve 602 represents a characteristic of a beam of which the gain becomes the maximum at an observation angle of 15 degrees, and a curve 603 represents a characteristic of a beam of which the gain becomes the maximum at an observed angle of 30 degrees. A curve 604 represents a characteristic of a beam of which the gain becomes the maximum at an observation angle of −15 degrees, and a curve 605 represents a characteristic of a beam of which the gain becomes the maximum at an observation angle of −30 degrees. Furthermore, a portion 611 surrounded by a circle of a dashed line represents a cross point between the curve 604 and the curve 605, and a portion 612 surrounded by a circle of a dashed line represents a cross point between the curve 601 and the curve 604. A portion 613 surrounded by a circle of a dashed line represents a cross point between the curve 601 and the curve 602, and a portion 614 surrounded by a circle of a dashed line represents a cross point between the curve 602 and the curve 603.

The cross point shown in FIG. 8 means that the gain at the cross point is low in detection of an object, the detection sensitivity degrades. In order to prevent the reduction of the gain at the cross point, it is preferable to arrange antenna element for each small observation angle.

However, if there is no structure in which the arrangement of the primary radiator is mechanically changed, the number of beams of the multi-beam radar apparatus is determined by the aperture area of the primary radiator or the setting of the number of mounted transmission or reception elements. Generally, in consideration of the influence of the spillover, the aperture length of the primary radiator increases, and thus, it is difficult to secure a space for arrangement of many antenna elements. Furthermore, since the transmitter/receiver of the microwave or millimeter wave band where the radar apparatus is mainly used is expensive, it is difficult to mount many elements due to the problem of cost. As described above, in the radar apparatus in the related art, since it is difficult to increase the number of beams in view of design or cost, in order to establish the system, the number of antenna elements should be set to the minimum number.

In the fixed type in the related art, since the distance between focuses of the multi-beams should be set according to the aperture area of the primary radiator, the number of beams is necessarily limited. Furthermore, in the fixed type in the related art, since the receiver of the microwave or millimeter wave band is also expensive, it is difficult to simply increase the number of focuses.

On the other hand, the radar apparatus 1 according to the first embodiment forms an array antenna capable of easily scanning the beam using the phase weight and appropriately perform the feeding at an appropriate position. Thus, in the radar apparatus 1 according to the first embodiment, it is possible to substantially increase the number of beams to be equal to or greater than that of the radar apparatuses in the related art.

As described above, in the radar apparatus 1 according to the first embodiment, it is possible to set the number of beams without an increase in the number of receivers and without restriction due to the aperture area of the primary radiator. That is, in the radar apparatus 1 according to the first embodiment, if the beam is set in a range where the radar apparatus can be designed, it is possible to easily perform the feeding to each beam by scanning the beam of the primary radiator according to an appropriate array combination. Furthermore, in the radar apparatus 1 according to the first embodiment, since it is possible to scan by adjusting the phase weight by the digital signal processing, it is possible to perform scanning remarkably faster than mechanical scanning, which is a very effective feeding method.

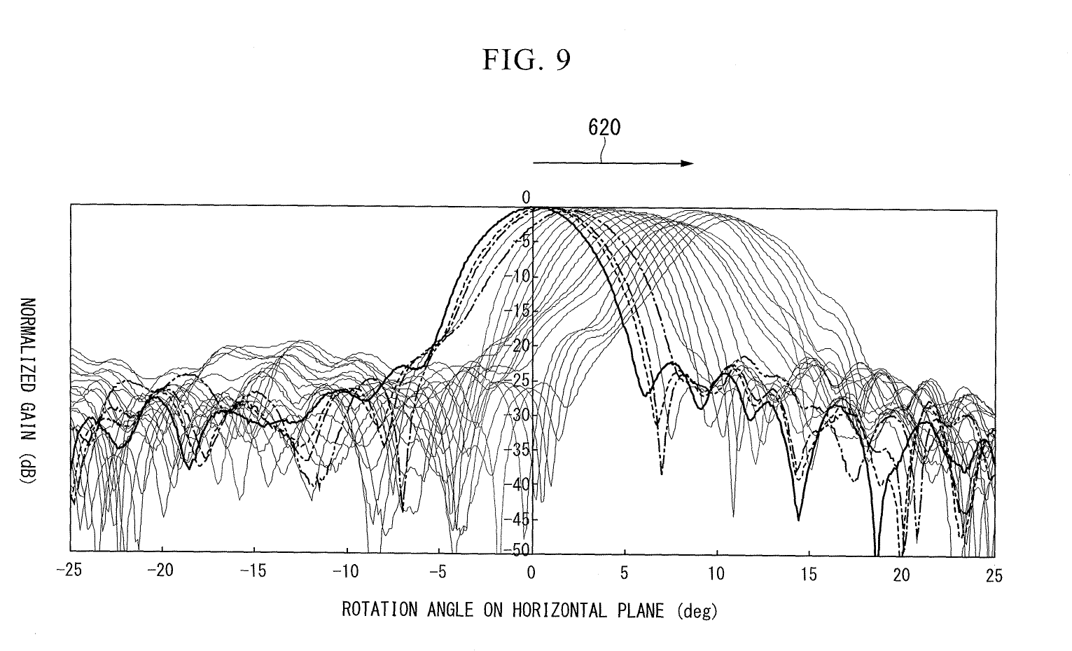

In the case of the multi-beam antenna of an extremely narrow range, even though the number of focuses does not increase, it is possible to infinitely arrange beams, as shown in FIG. 9, by beam steering of the primary radiator. Here, since the antenna characteristics degrade by defocusing, determination may be performed based on an application for use or required performances. FIG. 9 is a diagram illustrating an example of a beam pattern in adjustment of the phase weight of the antenna according to the first embodiment. In FIG. 9, the transverse axis represents a horizontal rotation angle, and the longitudinal axis represents a normarized gain.

The example shown in FIG. 9 shows an example of a beam pattern in the radar apparatus that emits three beams 60-1 to 60-3 formed by three array antennas 50-1 to 50-3 and the lens 30 in FIG. 1. An angle of the beam 60-1 with respect to the y axis is 0, an angle of the beam 60-2 with respect to the y axis is 5.5 degrees, and an angle of the beam 60-3 with respect to the y axis is 11 degrees. Furthermore, the example shown in FIG. 9 shows an example of a beam pattern in adjustment of the phase weight at an interval of 0.5 degrees, as indicated by an arrow 620. In this way, in the radar apparatus 1 according to the first embodiment, it is possible to generate multiple rotation angles where the gain becomes a peak by adjusting the phase weight. Thus, as shown in FIG. 9, in the radar apparatus 1 according to the first embodiment, it is possible to alleviate the cross point where the gain becomes low. Consequently, the radar apparatus 1 according to the first embodiment can be configured by a volume smaller than that of a radar apparatus in which an antenna element is movable, and can obtain the same characteristic as that of the radar apparatus in which the antenna element is mechanically movable.

Furthermore, in general, it is necessary to narrow the beam in order to increase the gain, but when the beam is narrowed, the drop of the cross point between beams becomes severe. In this regard, in the radar apparatus 1 according to the first embodiment, it is possible to obtain an effect capable of narrowing the beam and alleviating the drop of the cross point.

In the first embodiment, as shown in FIG. 1, the example in which the lens 30 is used is described, but a reflector may be used. FIG. 10 is a diagram schematically illustrating a configuration of a radar apparatus 1a using a transmission reflector according to the first embodiment. The radar apparatus 1a shown in FIG. 10 includes a transmission and reception control device 10, an antenna unit 20, and a reflector 80. Furthermore, the radar apparatus 1a includes a transmission antenna and a reception antenna, similar to the radar apparatus 1 shown in FIG. 1.

In the radar apparatus 1a shown in FIG. 10, similarly, the transmission and reception control device 10 may adjust a phase weight of each antenna element 20-n, to thereby adjust scanning of a beam. Furthermore, the transmission and reception control device 10 may adjust an excitation weight, to thereby adjust a side lobe of the beam. That is, the antenna unit 20 may be an array-of-array antenna configured by an antenna in which primary feeding is capable of being performed.

In the first embodiment, as shown in FIG. 1, an example in which each array antenna 50-n is configured by three antenna elements 20-n is described, but the invention is not limited to this embodiment. The number of the array antenna elements 50-n may be one or more according to a desired characteristic of the radar apparatus 1. Since the spillover is large when the feeding is performed at the end part, the number of the array antenna elements 50-n may be set so that the number of the array antenna elements 50-n increases at the end part compared with the center, for example.

### Second Embodiment

In a second embodiment, a case where a bifocal lens having different beam widths is used as a lens of a radar apparatus will be described.

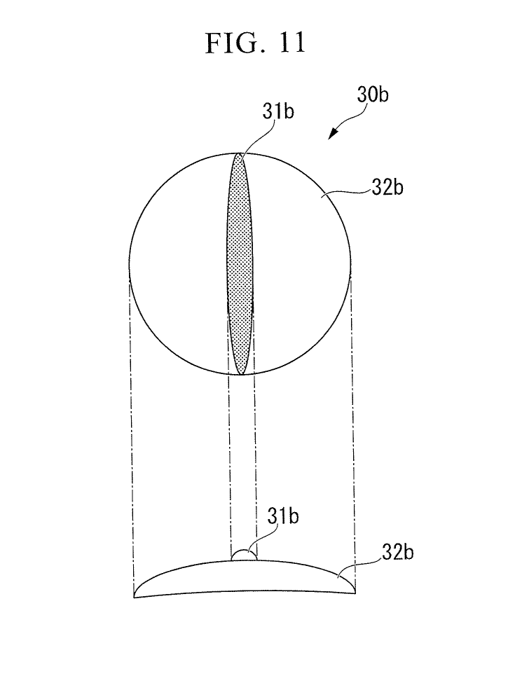

FIG. 11 is a diagram illustrating an example of a bifocal lens 30b according to the second embodiment.

An upper part in FIG. 11 represents a top view of the bifocal lens 30b, and a lower part in FIG. 11 represents a side view of the bifocal lens 30b.

As shown in FIG. 11, the bifocal lens 30b is configured so that a wide angle beam lens 31b of an elliptical shape is disposed at the center thereof, and a high-gain lens 32b with a large horizontal width is formed on the outside thereof.

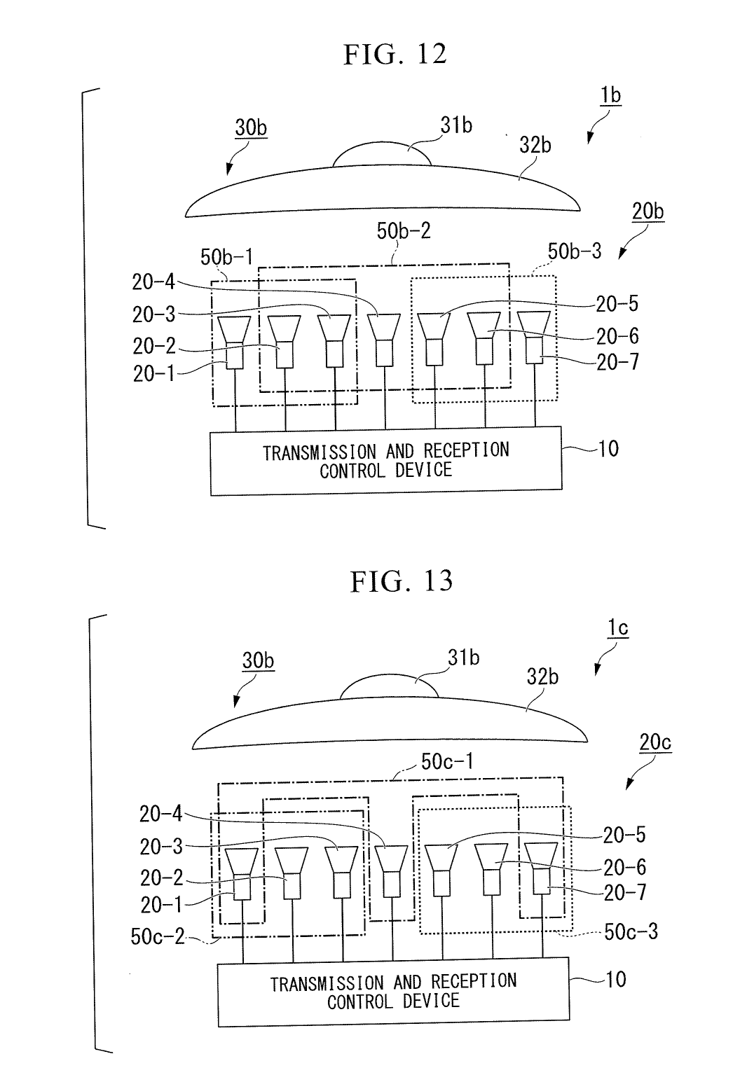

FIG. 12 is a diagram schematically illustrating a configuration of a radar apparatus 1b that uses the bifocal lens 30b according to the second embodiment. As shown in FIG. 12, the radar apparatus 1b includes a transmission and reception control device 10, an antenna unit 20b, and the bifocal lens 30b. The configuration of the transmission and reception control device 10 is the same as that of the transmission and reception control device 10 of the first embodiment (see FIG. 2).

The antenna unit 20b includes seven antenna elements 20-1 to 20-7, similarly to the first embodiment. Each antenna element 20-n (n is an integer of 1 to 7) is provided with a primary radiator (horn) having the same characteristic. Furthermore, each antenna element 20-n is arranged so that an emission direction of each antenna element 20-n is perpendicular to the x-axis direction. An interval between the antenna elements 20-n is equal in the x-axis direction, which is referred to as an interval “d”.

An array antenna 50b-1 includes three antenna elements 20-1, 20-2 and 20-3. An array antenna 50b-2 includes five antenna elements 20-2, 20-3, 20-4, 20-5 and 20-6. An array antenna 50b-3 includes three antenna elements 20-5, 20-6 and 20-7. That is, in the radar apparatus 1b according to the second embodiment, a combination of the antenna elements 20-n is selected according to a lens characteristic, and each array antenna 50-n is configured by the selected antenna elements 20-n.

In the radar apparatus 1b shown in FIG. 12, similarly, the transmission and reception control device 10 may adjust a phase weight of each antenna element 20-n, to thereby adjust scanning of a beam. Furthermore, the transmission and reception control device 10 may adjust an excitation weight, to thereby adjust a side lobe of the beam.

FIG. 13 is a diagram illustrating another combination of array antennas according to the second embodiment. As shown in FIG. 13, a radar apparatus 1c is different from the radar apparatus shown in FIG. 12 in an array of an antenna unit 20c.

The antenna unit 20c includes seven antenna elements 20-1 to 20-7, similar to the radar apparatus shown in FIG. 12.

An array antenna 50c-1 includes three antenna elements 20-1, 20-4 and 20-7. An array antenna 50c-2 includes three antenna elements 20-1, 20-2 and 20-3. An array antenna 50c-3 includes three antenna elements 20-5, 20-6 and 20-7.

With such a configuration, when the radar apparatus 1c performs feeding to the wide angle beam lens 31b at the center, it is possible to narrow the beam, similar to the radar apparatus shown in FIG. 12, by the three antenna elements 20-1, 20-4 and 20-7, to suppress the spillover. In FIG. 13, the array antenna 50c-1 can have the same effect as in the array antenna 50b-2 shown in FIG. 12. Furthermore, the array antenna 50c-1 has a small number of antenna elements compared with the array antenna 50b-2, but since the interval d of the antenna elements 20-n increases, the aperture area becomes large, and thus, it is possible to obtain an effect of narrowing the beam at a level equal to or higher than that of the array antenna 50b-2 shown in FIG. 12.

As described above, in the radar apparatus 1c shown in FIG. 13, similarly, the transmission and reception control device 10 may adjust a phase weight of each antenna element 20-n, to thereby adjust scanning of a beam. Furthermore, the transmission and reception control device 10 may adjust an excitation weight, to thereby adjust a side lobe of the beam.

In the storage unit 108 (see FIG. 2), antenna identifiers, phase weights and excitation weights are stored in association with the array antennas 50b-1 to 50b-3 or the array antennas 50c-1 to 50c-3 shown in FIGS. 12 and 13. In this case, the selector 111 (see FIG. 2) selects the array antenna 50b-n or 50c-n stored in the storage unit 108 by a reception selection signal from the timing control unit 101. Furthermore, the selector 111 selects the reception antenna elements 22-n corresponding to the number antenna elements set from the seven reception antenna elements 22-n, based on the antenna identification information stored in the storage unit 108 in association with the selected array antenna 50b-n or 50c-n. The selector 111 synthesizes reception signals after phase control and amplitude control from the selected reception antenna elements 22-n, and outputs the synthesized reception signal from the array antenna 50b-n or 50c-n to the A/D converter 112.

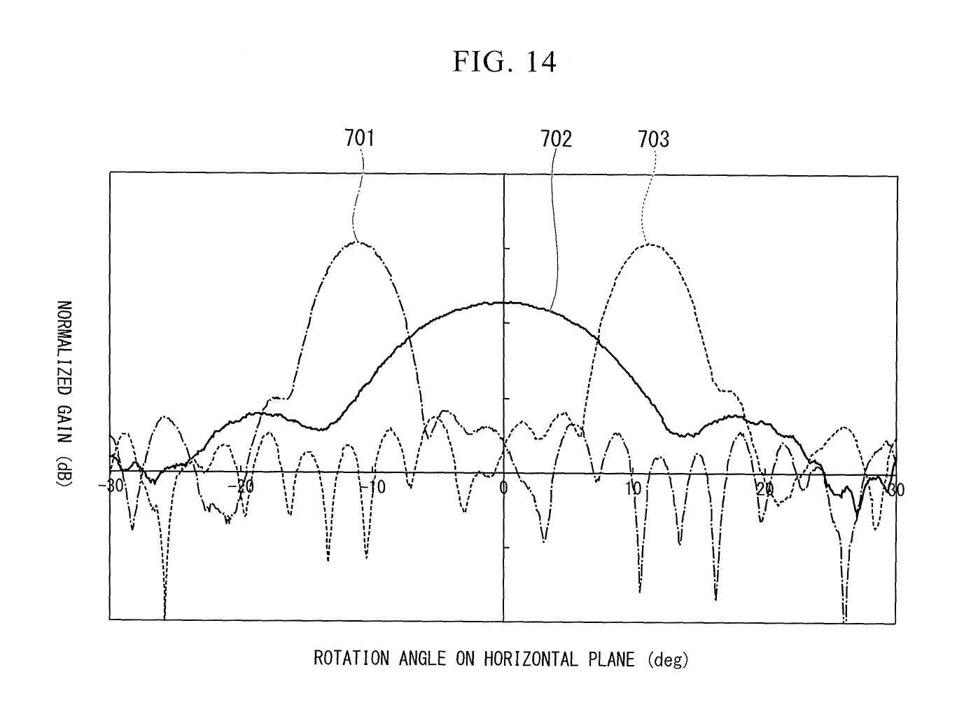

FIG. 14 is a diagram illustrating an example of a beam pattern using the bifocal lens 30b according to the second embodiment. Furthermore, the example shown in FIG. 14 is an example of a beam pattern based on the radar apparatus 1b in FIG. 12. In FIG. 14, the transverse axis represents a horizontal rotation angle, and the longitudinal axis represents a normarized gain.

A curve 701 represents a pattern of a beam emitted through the bifocal lens 30b by a radio wave emitted from the array antenna 50b-1. A curve 702 represents a pattern of a beam emitted through the bifocal lens 30b by a radio wave emitted from the array antenna 50b-2. A curve 703 represents a pattern of a beam emitted through the bifocal lens 30b by a radio wave emitted from the array antenna 50b-3.

In the primary radiator in the related art, since it is difficult to change the directionality, it is difficult to share the antenna element 20-n. However, in the radar apparatus 1b or 1c according to the second embodiment, it is possible to change the beam width for feeding by the various combinations of the number of the array antenna elements as shown in FIGS. 12 and 13. Thus, in the radar apparatus 1b or 1c according to the second embodiment, it is possible to share the antenna element 20-n.

In the second embodiment, in FIGS. 12 and 13, the example of the antenna elements 20-n where n is 7 is described, but the invention is not limited to this embodiment. The number of elements of the antenna elements 20-n may be changed according to a desired characteristic of the radar apparatuses 1b and 1c.

In the first and second embodiments, an example in which the interval between the antenna elements 20-n is equal is described, but the interval of the antenna elements 20-n may be not equal. Thus, in the radar apparatus 1 according to the first embodiment and the radar apparatus 1b or 1c according to the second embodiment, it is possible to change the beam width for feeding by combinations of elements having different intervals of the antenna elements 20-n.

Furthermore, in FIGS. 1, 12 and 13, the apertures of the antenna elements 20-n may be different from each other. For example, in FIG. 1, the antenna element 20-4 that is disposed approximately at the center of the lens 30 has a small spillover. On the other hand, the antenna elements 20-1 and 20-7 disposed on both sides of the lens 30 have a large spillover compared with the antenna element 20-1. Thus, by using an antenna of a characteristic of a small aperture area in the antenna element 20-4 and using an antenna element of a large aperture area in the antenna elements 20-1 and 20-7, the beam may be narrowed.

Furthermore, in the first and second embodiments, as shown in FIG. 2, an example in which the phase control unit 106-n controls the phase of the reception signal received by the reception unit 109-n and the amplitude control unit 107-n controls the amplitude of the reception signal received by the reception unit 109-n is described, but the invention is not limited to these embodiments. For example, the amplitude and phase of the reception signal of the transmission unit 105-n may be controlled based on the phase weight and the excitation weight stored in the storage unit 108. Furthermore, the phase weight and the excitation weight for transmission and the phase weight and the excitation weight for reception may be the same or different from each other.

### Third Embodiment

In a third embodiment, an example in which a control is performed so that a peak of a side lobe in an antenna pattern and a null point overlap each other as a phase control unit 106d-n controls the phase and an amplitude control unit 107d-n controls the amplitude for the reception antenna (see FIG. 2) will be described.

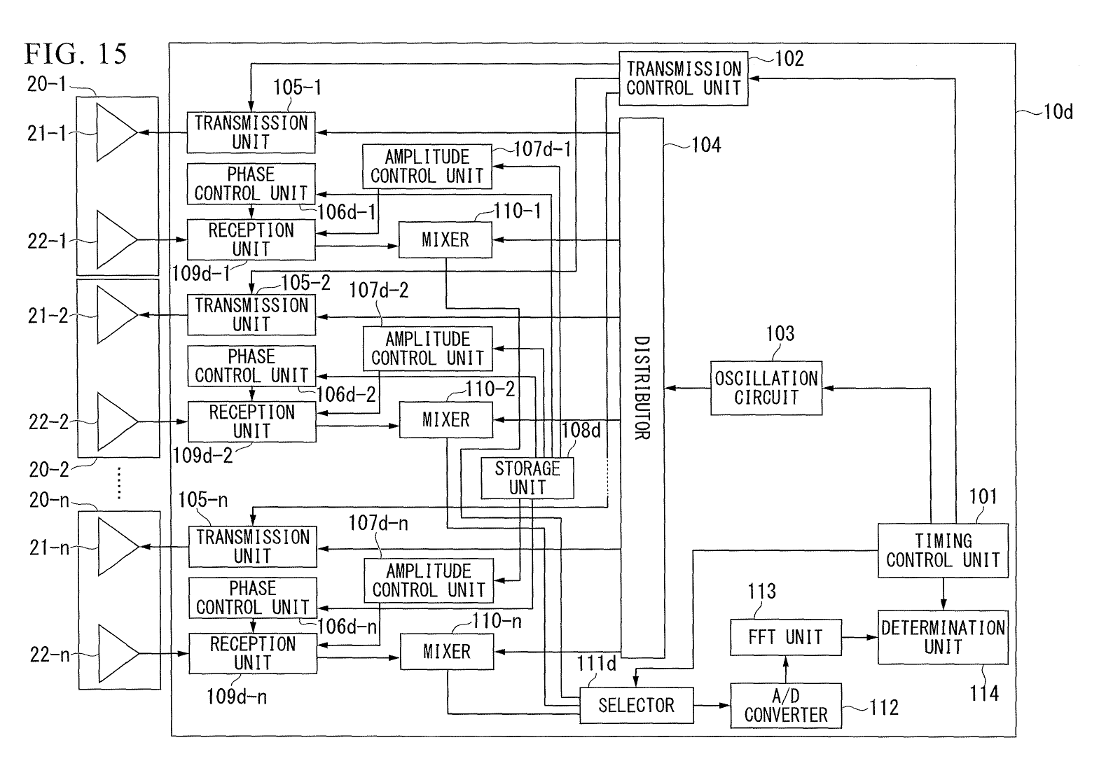

FIG. 15 is a block diagram illustrating a configuration of a transmission and reception control device 10d according to the third embodiment. The same reference numerals are given to functional units having the same functions as in FIG. 2, and description thereof will not be repeated. The transmission and reception control device 10d according to the third embodiment is different from the device shown in FIG. 2 in the phase control unit 106d-n, the amplitude control unit 107d-n, a storage unit 108d, a reception unit 109d-n and a selector 111d.

The phase control unit 106d-n reads a phase weight for reception stored in the storage unit 108d, and controls the phase of a reception signal received by the reception unit 109d-n according to the read phase weight.

The amplitude control unit 107d-n reads an excitation weight for reception stored in the storage unit 108d, and controls the amplitude of the reception signal received by the reception unit 109d-n according to the read excitation weight.

Antenna identification information, a phase weight for transmission and an excitation weight for transmission are stored in the storage unit 108d in association, for each array antenna 50-n. Furthermore, the antenna identification information, the phase weight for reception and the excitation weight for reception are stored in the storage unit 108d in association, for each array antenna 50-n.

The reception unit 109d-n receives the reception signal input through the reception antenna element 22-n. The reception unit 109d-n outputs the reception signal of which the phase is controlled by the phase control unit 106d-n and the amplitude is controlled by the amplitude control unit 107d-n to a mixer 110-n.

The selector 111d selects the array antenna 50-n stored in the storage unit 108d by a reception selection signal from the timing control unit 101. Furthermore, the selector 111d selects reception antenna elements 22-n corresponding to the number set from among the seven reception antenna elements 22-n based on the antenna identification information stored in the storage unit 108d in association with the selected array antenna 50-n. The selector 111d synthesizes the reception signals after phase control and amplitude control, received through the selected reception antenna elements 22-n, and outputs the synthesized reception signal in the array antenna 50-n to the A/D converter 112.

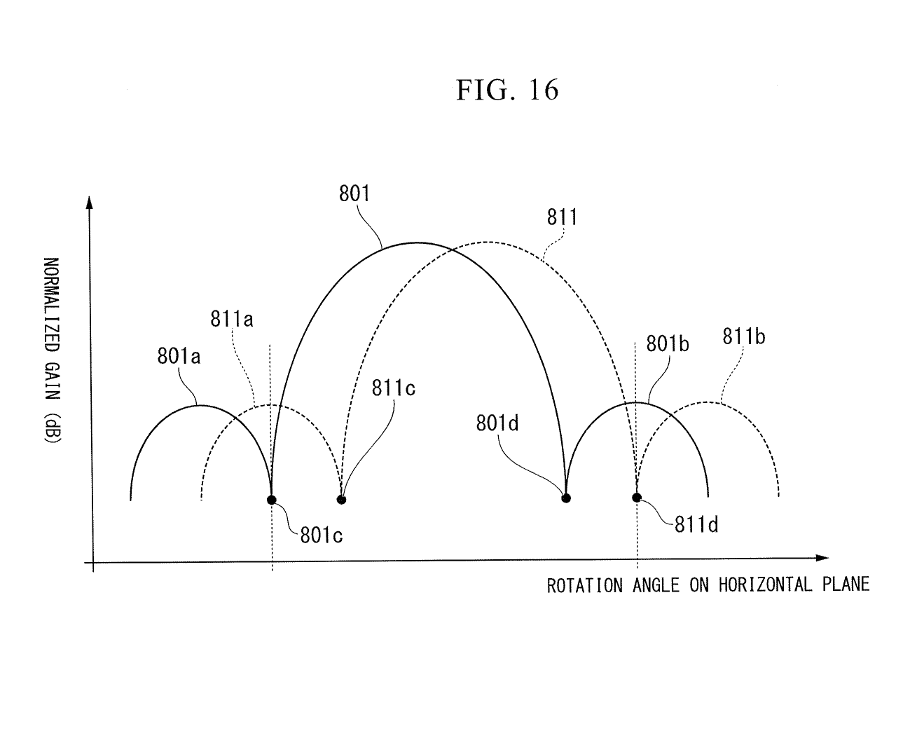

FIG. 16 is a diagram illustrating an antenna pattern based on the reception antenna element 22-n according to the third embodiment. In FIG. 16, the transverse axis represents a rotation angle on a horizontal plane, and the longitudinal axis represents a normarized gain.

In FIG. 16, a curve 801 represents an antenna pattern based on a first reception antenna element 22-n (see FIG. 15), and a curve 811 represents an antenna pattern based on a second reception antenna element 22-n. Reference numerals 801a and 801b represent side lobes corresponding to the first reception antenna element 22-n, and reference numerals 801c and 801d represent null points corresponding to the first reception antenna element 22-n. Reference numerals 811a and 811b represent side lobes corresponding to the second reception antenna element 22-n, and reference numerals 811c and 811d represent null points corresponding to the second reception antenna elements 22-n. The first reception antenna element 22-n and the second reception antenna element 22-n are two different reception antenna elements 22-n (for example, reception antenna elements 22-1 and 22-2) that are included in two antenna elements 20-n (for example, antenna elements 20-1 and 20-2) included in the same array antenna 50-n (for example, an array antenna 50-1).

As shown in FIG. 16, the phase control unit 106-n of the transmission and reception control device 10d according to the third embodiment controls the phase of the reception signal received by the first reception antenna element 22-n and the phase of the reception signal received by the second reception antenna element 22-n so that the side lobe points of the first reception antenna element 22-n and the null points of the second reception antenna element 22-n overlap each other.

Furthermore, the amplitude control unit 107-n of the transmission and reception control device 10d according to the third embodiment controls the amplitude of the reception signal received by the first reception antenna element 22-n and the amplitude of the reception signal received by the second reception antenna element 22-n so that the side lobe points of the first reception antenna element 22-n and the null points of the second reception antenna element 22-n overlap each other.

As described above, the radar apparatuses 1, 1b and 1c according to the third embodiment include the phase control unit 106d-n that controls the phase of the signal received by the antenna elements 20-n that form the partial antenna, based on at least one of the number of the antenna elements 20-n that form the partial antenna (array antenna 50-n), the interval of the antenna elements 20-n, the value indicating the directionality of the antenna element 20-n, and the aperture of the array antenna; and the amplitude control unit 107d-n that controls the amplitude of the signal received by the antenna elements 20-n that form the partial antenna, based on at least one of the number of the antenna elements 20-n that form the partial antenna, the interval of the antenna elements 20-n, the value indicating the directionality of the antenna element 20-n and the aperture of the array antenna, in which the phase control unit 106d-n adjusts the phase of the signal received by the antenna elements 20-n that form the partial antenna so that the side lobe points of the antenna pattern of the first antenna element and the null points of the second antenna element overlap each other, and the amplitude control unit 107d-n adjusts the amplitude of the signal received by the antenna elements 20-n that form the partial antenna so that the side lobe points of the antenna pattern of the first antenna element and the null points of the second antenna element overlap each other.

Thus, when the antenna pattern based on the first reception antenna element 22-n and the antenna pattern based on the second reception antenna element 22-n are synthesized, it is possible to reduce the size of the side lobes on both sides of the synthesized beam. Here, it is preferable that the side lobe point that overlaps the null point be present in the vicinity of a point where the gain of the side lobe is the largest.

In general, in order to cause the side lobe and the null point to overlap each other, in view of design of the radar apparatus, many restrictions are generated in the content of the design. On the other hand, in the radar apparatus 1 (including 1b and 1c) according to the third embodiment, by controlling the phase or amplitude of the reception signal received by the first reception antenna element 22-n and the phase or amplitude of the reception signal received by the second reception antenna element 22-n, it is possible to cause the side lobe point of the first reception antenna element 22-n and the null point of the second reception antenna element 22-n to overlap each other.

Furthermore, in the third embodiment, an example in which the side lobes and the null points on both sides of a main lobe overlap each other is described, but the invention is not limited to this embodiment. For example, the transmission and reception control device 10d may perform control so that secondary side lobes that are present second next to the main lobe, tertiary side lobes or the like and the null points overlap each other.

In the third embodiment, an example in which the phase and the amplitude are adjusted for two reception antenna elements 22-n in order to reduce the side lobes of the synthesized beam is described, but the radar apparatus 1 (including 1b and 1c) may be configured so that the phase and the amplitude are adjusted for two reception antenna elements 22-n for each array antenna 50-n.

Furthermore, an example in which the beam pattern in which the null points and the side lobes overlap each other is formed between the reception antenna elements 22-n is described, but the beam pattern may be formed between the transmission antenna elements 21-n. Alternatively, in the radar apparatus 1 (including 1b and 1c), the phase and the amplitude may be adjusted so that the null points and the side lobes overlap each other in the transmission antenna element 21-n and the reception antenna element 22-n.

### Fourth Embodiment

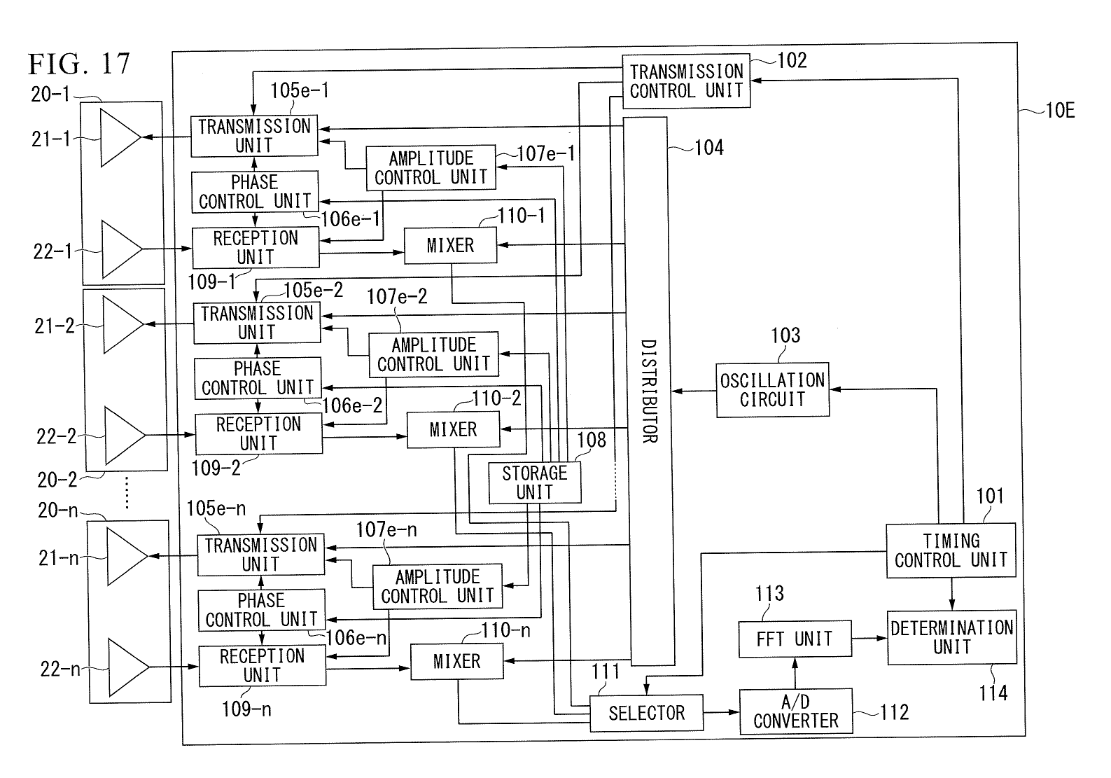

FIG. 17 is a block diagram illustrating a configuration of a transmission and reception control device 10E according to a fourth embodiment. As shown in FIG. 17, the transmission and reception control device 10E includes a timing control unit 101, a transmission control unit 102, an oscillation circuit 103, a distributor 104, a transmission unit (transmission and reception unit) 105e-n (n is an integer of 1 to 7), a phase control unit 106e-n, an amplitude control unit 107e-n, a storage unit 108, a reception unit (transmission and reception unit) 109-n, a mixer 110-n, a selector 111, an A/D converter 112, an FFT unit 113, and a determination unit 114. The same reference numerals are given to functional units having the same functions as in the transmission and reception control device 10 (see FIG. 2) described in the first embodiment, and description thereof will not be repeated.

As shown in FIG. 17, the transmission and reception control device 10E is different from the transmission and reception control device 10 in that the phase control unit 106e-n also performs the phase control and the amplitude control unit 107e-n also performs the amplitude control, with respect to the transmission units 105e-1 to 105e-n.

The phase control unit 106e-n reads a phase weight stored in the storage unit 108, and controls the phase of a transmission signal to be transmitted by the transmission unit 105e-n according to the read phase weight. The phase control unit 106e-n reads the phase weight stored in the storage unit 108, and controls the phase of a reception signal received by the reception unit 109-n according to the read phase weight.

The amplitude control unit 107e-n reads an excitation weight stored in the storage unit 108, and controls the amplitude of the transmission signal to be transmitted by the transmission unit 105e-n according to the read excitation weight. The amplitude control unit 107e-n reads the excitation weight stored in the storage unit 108, and controls the amplitude of the reception signal received by the reception unit 109-n according to the read excitation weight.

The phase weight and the excitation weight for transmission and the phase weight and the excitation weight for reception, stored in the storage unit 108, may be different from each other.

In the transmission and reception control device 10E, the transmission antenna elements 21-1 to 21-n form the array antenna 50-n, for example. In the fourth embodiment, the array antenna 50-n controls the phase and the amplitude of the transmission antenna elements 21-1 to 21-n to control the directionality of a transmission beam.

For example, when a car navigation system, an on-board camera or the like is mounted on a vehicle mounted with the transmission and reception control device 10E, the transmission and reception control device 10E obtains information relating to a road environment where the vehicle travels from the car navigation system, the on-board camera or the like. Here, the information relating to the road environment refers to information such as a driveway direction or a sidewalk direction, for example. In this case, the transmission and reception control device 10E can sweep a beam with high efficiency in the driveway direction or the sideway direction.

Alternatively, when the information relating to the road environment may be obtained in advance, the transmission and reception control device 10E may perform control so that the beam is not swept in a direction of a road structure that is a noise source (a generation source of a reflection wave that is a cause of multi paths). The road structure refers to a bridge girder, a telegraph pole, a signboard or the like, for example.

Alternatively, the transmission and reception control device 10E sequentially analyzes the reception signal received by the array antenna 50-n, and generates information relating to the road environment according to the analysis result. The transmission and reception control device 10E may control the beam of the transmission wave based on the generated information related to the road environment to perform the beam control with high efficiency.

Thus, the transmission and reception control device 10E of the fourth embodiment can reduce a scanning time interval of the transmission beam.

Furthermore, in the fourth embodiment, since it is possible to adjust the phase weight for each transmission antenna element 21-n, it is possible to adjust the wave surface in a desired direction. Furthermore, in the fourth embodiment, since the transmission antenna element 21-n is shared, a substantial aperture becomes large, and thus, it is possible to obtain an effect of narrowing the beam.

With such a configuration, in the radar apparatus 1 according to the fourth embodiment, it is possible to detect the azimuth of the detection object with high accuracy by the combination of the array-of-array antenna (partial antenna) and the lens 30 (or reflector), without increasing the size and cost of the radar apparatus. Furthermore, with such a configuration, in the radar apparatus 1 according to the fourth embodiment, it is possible to change the beam direction by adjusting the phase, and thus, it is possible to electrically adjust the emission direction without physically moving the emission direction of the antenna element. Furthermore, in the radar apparatus 1 according to the fourth embodiment, it is possible to change the side lobes by adjusting the amplitude.

Furthermore, the radar apparatus 1 according to the fourth embodiment is provided with the array antenna capable of easily scanning the phase weight or performing appropriate feeding at an appropriate position. Thus, in the radar apparatus 1 according to the fourth embodiment, it is possible to increase the number of beams compared with the related art technique.

In the fourth embodiment, an example in which the phase control and the amplitude control are performed for both of the transmission unit 105e-n and the reception unit 109-n is described, but the phase control and the amplitude control may be performed only for the transmission unit 105e-n.

In the first to fourth embodiments, as shown in FIGS. 1, 5, 10, 12 and 13, an example in which the antenna elements 20-1 that form the array antenna 50-1 is arranged in a straight line, but the invention is not limited to these embodiments. The antenna elements 20-1 may not be arranged in the straight line. In this case, the transmission and reception control device 10 (including 10d) may control the phase and the amplitude of each antenna element 20-1 according to the characteristic of the lens 30 or the reflector 80 and a desired beam.

Part of the functions of the radar apparatuses 1, 1b and 1c in the above-described first to fourth embodiments may be realized in a computer. In this case, a program for realization of the control function may be recorded on a computer readable recording medium, and the computer system may read the program recorded on the recording medium or execution. The “computer system” refers to a computer system built in the radar apparatuses 1, 1b and 1c, which includes an operating system and hardware such as a peripheral device. Furthermore, the “computer readable recording medium” refers to a portable medium such as a flexible disk, a magneto-optical disk, a ROM or a CD-ROM, and a storage unit such as hard disk built in the computer system. Furthermore, the “computer readable recording medium” may include a medium that dynamically retains a program in a short period of time, such as a communication line where the program is transmitted through a network such as the internet or a communication line such as a telephone line, and a medium that retains a program for a predetermined time, such as a volatile memory in the computer system that serves as a server or a client in this case. Furthermore, the program may realize a part of the above-described functions, or may realize the above-described functions by combination with the program that is already recorded in the computer system.

Furthermore, a part or all of the functions of the radar apparatuses 1, 1b and 1c according to the above-described embodiments may be realized as an integrated circuit such as a large scale integration (LSI).

The functional blocks of the radar apparatuses 1, 1b and 1c according to the above-described embodiments may be individually realized as a processor, or part or all thereof may be integrated as a processor. Furthermore, a method of realizing the integrated circuit is not limited to the LSI, but may be realized as an exclusive circuit or a general-use processor. Furthermore, if a technique of an integration circuit that replaces the LSI is proposed according to the advance of semiconductor technology, an integrated circuit based on the corresponding technology may also be used.

What is claimed is:

1. An on-board radar apparatus comprising:
an antenna unit configured by combining one of a lens and a reflector, and a plurality of antenna elements;
a transmission and reception unit configured to emit a radio wave using, for at least one of transmission or reception, a partial antenna of a plurality of patterns configured by the antenna elements that are part of the plurality of antenna elements, and to receive a reflection wave obtained by reflection of the radio wave from an object; and
a detection unit configured to detect the object based on the reflection wave received by the transmission and reception unit.

2. The on-board radar apparatus according to claim 1,
wherein a combination of the antenna elements that form the partial antenna is selected according to a characteristic of one of the lens and the reflector.

3. The on-board radar apparatus according to claim 1, further comprising:
a phase control unit configured to control a phase of a signal based on a radio wave received by the antenna elements that form the partial antenna, based on at least one of a number of the antenna elements that form the partial antenna, an interval of the antenna elements, a value indicating directionality of the antenna elements and an aperture surface of an array antenna configured by the plurality of antenna elements.

4. The on-board radar apparatus according to claim 1, further comprising:
an amplitude control unit configured to control an amplitude of a signal based on a radio wave received by the antenna elements that form the partial antenna, based on at least one of a number of the antenna elements that form the partial antenna, an interval of the antenna elements, a value indicating directionality of the antenna elements and an aperture surface of an array antenna configured by the plurality of antenna elements.

5. The on-board radar apparatus according to claim 3, further comprising:
an amplitude control unit configured to control an amplitude of the signal based on the radio wave received by the antenna elements that form the partial antenna, based on at least one of a number of the antenna elements that form the partial antenna, the interval of the antenna elements, the value indicating the directionality of the antenna elements and the aperture surface of the array antenna configured by the plurality of antenna elements.

6. The on-board radar apparatus according to claim 1,
wherein the plurality of antenna elements is arranged in a straight line.

7. The on-board radar apparatus according to claim 3,
wherein at least one of the number of the antenna elements that form the partial antenna, the interval of the antenna elements, the value indicating the directionality of the antenna elements and the aperture surface of the array antenna configured by the plurality of antenna elements is selected according to a characteristic of one of the lens and the reflector.

8. The on-board radar apparatus according to claim 4,
wherein at least one of the number of the antenna elements that form the partial antenna, the interval of the antenna elements, the value indicating the directionality of the antenna elements and the aperture surface of the array antenna configured by the plurality of antenna elements is selected according to a characteristic of one of the lens and the reflector.

9. The on-board radar apparatus according to claim 5,
wherein the phase control unit adjusts the phase of the signal received by the antenna elements that form the partial antenna so that a side lobe point of an antenna pattern of a first antenna element that is one of the plurality of antenna elements included in the partial antenna and a null point of a second antenna element that is included in the partial antenna and is one of the plurality of antenna elements except for the first antenna element overlap each other, and
wherein the amplitude control unit adjusts the amplitude of the signal received by the antenna elements that form the partial antenna so that the side lobe point of the antenna pattern of the first antenna element and the null point of the second antenna element overlap each other.
